(19) United States
(12) Patent Application Publication
(10) Pub. No.: US 2008/0202694 A1
(43) Pub. Date: Aug. 28, 2008

(54) FLUID FLOW PATH IN MICROFLUIDIC DEVICE

(76) Inventors: Jeffrey P. Serbicki, Holley, NY (US); Mario J. Ciminelli, Rochester, NY (US); Randy J. Kennard, Palmyra, NY (US)

Correspondence Address: Patent Legal Staff;Eastman Kodak Company, 343 State Street, Rochester, NY, 14650-2201, US

(21) Appl. No.: 11/678,647

(22) Filed: Feb. 26, 2007

(51) Int. Cl. B41J 2/00

(52) U.S. Cl. 156/538; 156/325; 347/110

(57) ABSTRACT

A fluid flow path, a microfluidic device including the fluid flow path, and methods of forming the same are described. The fluid flow path can include an inlet and at least one outlet, and is defined by a first substrate and a second substrate, each having one or more fluid via extending therethrough, and an adhesive sealant between the first substrate and the second substrate, wherein the adhesive sealant surrounds at least one via of each substrate such that fluid flows through the vias and an area bounded by the adhesive sealant between the substrates. The adhesive sealant can be a bismaleimide-containing compound.

### FIELD OF THE INVENTION

This invention relates generally to the field of microfluidic devices, and in particular to use of an adhesive sealant to define a fluid flow path between two components of a microfluidic device.

### BACKGROUND OF THE INVENTION

There is a class of devices, called microfluidic devices, in which the device is used to move or process very small amounts of fluid. Microfluidic devices are employed in a wide range of fluid processing applications, including those in printing, medical, chemical, biochemical, genetic, automotive, and energy fields. Examples of microfluidic devices include bioassays, chemical assays, gene sequencers, engines, and print heads. Such devices typically have an inlet for the fluid, an optional fluid processing region, and fluidic passageways through which the fluid flows from the inlet to the fluid processing region, and/or to an outlet. In certain applications, the microfluidic device can include a semiconductor device that is microelectronically packaged in order to provide electronic connection and protection, and to facilitate movement of the fluid in the device.

Microfluidic devices can include one or more fluid flow paths that extend at least partially through the device, ending in a reservoir or outlet. Where the fluid flow paths are formed between substrates of a device that are adhesively bonded, the fluid flow path needs to be reliably sealed in order to prevent leakage and cross-contamination of adjacent fluid flow paths. Reliable sealing requires accurate deposition of an adhesive sealant material in a precise area, and excellent long-term chemical compatibility between the sealant material and the fluid(s) introduced into the flow path. Especially for substrates of different materials that are adhesively bonded together, because of differences in substrate thermal expansion coefficients, adhesive sealants must be selected that can accommodate appropriate shear stress, thermal stress, and other stresses on the device. The choice of adhesive sealant also affects cost, manufacturing process, and production time due to application and curing requirements.

Thus, there is a need for a microfluidic device and a method of forming the same wherein the fluid flow paths are achieved through use of an adhesive sealant capable of accurate patterning and having chemical robustness low stress, rapid cure, and good thermal conductivity.

### SUMMARY OF THE INVENTION

The present invention is directed to overcoming one or more of the problems set forth above. The invention is directed to a fluid flow path, and a method of forming the same, wherein the fluid flow path comprises an inlet and at least one outlet, and is defined by a first substrate having a first surface and a second surface, and at least one fluid via; a second substrate having a first surface and a second surface, and one or more fluid via; and an adhesive sealant between the second surface of the first substrate and the first surface of the second substrate, wherein the sealant surrounds at least one first substrate fluid via and at least one second substrate fluid via such that fluid entering at least one first substrate fluid via flows through the via, through an area bounded by the adhesive sealant and through one or more second substrate fluid via, wherein the adhesive sealant comprises bismaleimide. A microfluidic device incorporating the fluid flow path and a method of making the same are also described and claimed.

### ADVANTAGEOUS EFFECT OF THE INVENTION

The present invention provides for formation of one or more fluid flow path in a microfluidic device using an adhesive sealant, wherein the adhesive sealant has excellent chemical resistiveness, low stress, good thermal conductivity, and achieves a rapid cure to speed production.

### BRIEF DESCRIPTION OF THE DRAWINGS

The above and other objects, features, and advantages of the present invention will be apparent when taken in conjunction with the following description and drawings, wherein:

FIG. 1 is a top view of a portion of a portion of a printhead;

FIG. 2 is a cross-sectional view of the portion of the printhead of FIG. 1 along line A-A;

FIG. 3 is a top view of another portion of a printhead; and

FIG. 4 is a cross-sectional view of the portion of the printhead of FIG. 3 along line B-B.

To facilitate understanding, identical reference numerals have been used, where possible to designate identical elements that are common to the figures. The figures are not drawn to scale, and are representative only.

### DETAILED DESCRIPTION OF THE INVENTION

Formation of fluid flow paths in microfluidic devices poses many challenges. Such flow paths can be very small, subject to differences in pressure and temperature, and subject to clogging. Also, depending on the fluid type, such paths can be subject to chemical degradation or aggregation. The size and type of the device can also add stresses, such as flex, and thermal expansion, which may affect the fluid flow paths or the reliable functioning of the microfluidic device.

Fluid flow paths can be formed directly in the material of one or more substrate, defined by an adhesive sealant bonding two or more substrates together, or a combination of all of the above. Fluid flow paths can be planar or three-dimensional, and may extend horizontally, vertically, or at angles from the horizontal or vertical through one or more substrate in the device. A fluid flow path can include one or more reservoir, wherein a reservoir has a larger capacity for holding fluid than other areas of the fluid flow path.

An adhesive sealant used to define a fluid flow path in part or in whole between two or more substrates can possess physical and chemical characteristics determined by the application of the fluid flow path. For example, the adhesive sealant can be hydrophobic to prevent or minimize absorption of the fluid in the fluid flow path, as well as minimizing the effect of ambient humidity on the fluid flow path. The adhesive sealant can be gas impermeable, selectively permeable, or permeable. The adhesive sealant can be flexible, minimizing stress on the device. The adhesive sealant can be thermally conductive to aid in dispersing heat. The adhesive sealant can be electrically conductive.

Adhesive sealant compositions that provide hydrophobicity and flexibility while maintaining strength can include bismaleimide. Suitable compositions can include, but are not limited to, those set forth, for example, in U.S. Pat. Nos. 6,034,195; 6,034,194; 6,825,245; 6,916,856; and 6,960,636, and US Patent Application Publications US 2002/0193541, US 2003/0087999, US 2005/0107542, US 2005/0136620, and US 2005/0137277. Other suitable compositions including bismaleimide include the Hysol® line of products made by Henkel Loctite®, San Diego, Calif., USA.

Bismaleimide-containing adhesive sealant compositions can include fillers to provide thermal or electrical conductivity, or to modify the rheology of the adhesive sealant. Examples of suitable electrically conductive fillers include, for example, but are not limited to, silver, nickel, copper, aluminum, palladium, gold, graphite, and metal-coated graphite (e.g., nickel-coated graphite, and silver-coated graphite). Examples of suitable thermally conductive fillers include, but are not limited to, graphite, aluminum nitride, silicon carbide, boron nitride, diamond dust, and alumina. Compounds that act primarily to modify rheology can include but are not limited to fumed silica, alumina, titania, and high surface area smectite clays.

Conditions suitable to cure the bismaleimide-containing adhesive sealants comprise subjecting the adhesive sealant to a temperature of from 80° C. to over 200° C. for 0.25 to 60 minutes. Because the adhesive sealant is typically applied to a device, then cured, the curing temperature and time should not affect the physical structure or electrical conductivity, if any, of the device components subjected to the curing conditions. The bismaleimide-containing adhesive sealant can be cured at low temperatures, for example, 125° C. or less, for about 0.25 to 30 minutes. Higher temperatures and/or times can be used if suitable for the device component undergoing the curing conditions.

The ability to cure at low temperatures, for example, at about 125° C. or less, enables use of the adhesive sealant with more material types. For example, if the materials being adhered contain, or are in contact with, a thermosensitive material, for example, a thermoplastic, exposure to high temperature during curing of the adhesive sealant can soften the thermosensitive material depending on curing temperature. Softening of the material can include movement of any portion of the material due to deformation, warping, flowing, or melting. If the thermosensitive material includes any alignment or registration feature, such as a datum, softening of the material may affect the alignment feature such that it no longer functions. As an example, printhead dies for inkjet printers can be bonded and fluidically sealed to a ceramic substrate that is attached to a thermoplastic material. For example, the ceramic material may be co-molded with a thermoplastic material during an injection molding process. The thermoplastic material optionally can include alignment features, such as datums, for use in fitting the printhead into the print mechanism. See, for example, copending U.S. application Ser. No. 11/614,143, filed Dec. 21, 2006, titled “Insert Molded Printhead Substrate” to Petruchik et al. The thermoplastic material can soften at a temperature of about 140° C. or less, and can begin softening at temperatures as low as 125° C., resulting in warping of the thermoplastic material and movement of the datums, preventing accurate alignment of the printhead in the print mechanism. Curing of the adhesive sealant forming a fluid flow path in the printhead at temperatures at or below 125° C. is thus desirable in order to prevent distortion of the datums. The aforementioned bismaleimide-containing materials can be cured at the desirable temperatures in a short amount of time, for example, from 0.25 to 30 minutes, or 15 to 30 minutes.

It is desirable the adhesive sealant alleviate stresses between the adhered substrates or device components. It is known that the larger the surface area bonded, the greater the stress that is created on the bond. Larger surface areas experience more stress from shear, flex, and thermal expansion differentials than smaller surface areas. Large devices that include adhesively bonded materials that differ in thermal expansion can require very different adhesive or bonding agents in order to accommodate stress. For example, epoxies are known for use as adhesives in printheads used in low printing speed consumer ink jet printers, wherein the printheads have a small surface area, being for example about 10 to 15 mm in length. Higher printing speed ink jet printers require a different adhesive material due to the increased shear forces, flexing, and thermal expansion differentials of the adhered materials over the surface area of the printhead, wherein the printhead can be 2 cm or more in length, with some printheads being about 10 cm or more in length. Thermal stress due to differential thermal expansion of bonded materials occurs during adhesive curing. Because after the curing occurs at raised temperatures, the material with the higher coefficient of thermal expansion shrinks more during cooling to ambient temperature than the other bonded material, placing stress on the adhesive bond. Such stresses can be particularly damaging for a large inkjet printhead die that also contains one or more elongated ink inlet throughhole. In such a case, a silicon die containing one or more elongated fluid inlet throughhole is bonded to a ceramic substrate having one or more corresponding fluid pathway through it, such that the fluid path of the assembly includes the fluid pathway through the ceramic substrate, the fluid inlet hole or slot in the silicon die, and the adhesive sealant that bonds the two and forms a fluid seal around the respective openings. The inventors have found bismaleimide-containing adhesive sealants can accommodate the increased shear and flex stresses over large surface areas, where epoxies are known to fail.

Depending on the device, any combination of organic and/or inorganic materials can be adhered. For example, adhered materials can include metals, metal oxides, polymers, thermoplastics, silicon, and ceramics. The inventors have found bismaleimide-containing adhesive sealants tolerate and ameliorate thermal stresses between materials. The bismaleimide-containing adhesive sealant can include one or more filler that is thermally conductive to aid in thermal transfer and heating or cooling of the device as needed. Good thermal transfer can be particularly important in a thermal inkjet printhead, in which it is necessary to remove heat generated within the silicon die during printing. Such fillers arc discussed elsewhere herein, and are generally known in the art.

A further advantage of the bismaleimide-containing adhesive sealant is chemical resistance. Such adhesives sealants are hydrophobic, and are generally non-reactive. Such adhesive sealants also have low outgassing, and form void-free bond lines or seals.

The adhesive sealant can be applied to a substrate or other device component by any known methods. For example, the sealant can be applied using various configurations of dispensing valves or nozzles, such as, but not limited to, pneumatic, auger, and positive displacement type valves. These valves or nozzles can be stationary or movable, wherein one or both of the valves and substrate can be movable by a system that accurately moves in the X, Y and Z dimensional planes during the application of the sealant. The sealant can also be applied using screen or stencil printing methods as known in the art. Optionally, the adhesive sealant can be made into a B-staged film or pre-form film for application to the device component followed by final cure.

To demonstrate a fluid flow path defined in part by an adhesive sealant as described herein, a fluid flow path in a portion of an ink jet printhead will be described with reference to the Figures. The example of an ink jet printhead was chosen to demonstrate the use of an adhesive sealant in an environment that undergoes shear stress, thermal stress, and flex stress, and is subjected to harsh chemicals

Ink jet printing can be achieved using two different technologies, drop-on-demand and continuous stream or continuous ink jet printing. In each technology, ink is fed through channels formed in a printhead to a nozzle from which drops of ink are selectively extruded and deposited upon a medium. When color printing is desired, independent ink supplies and separate ink delivery systems for each ink color are typically used.

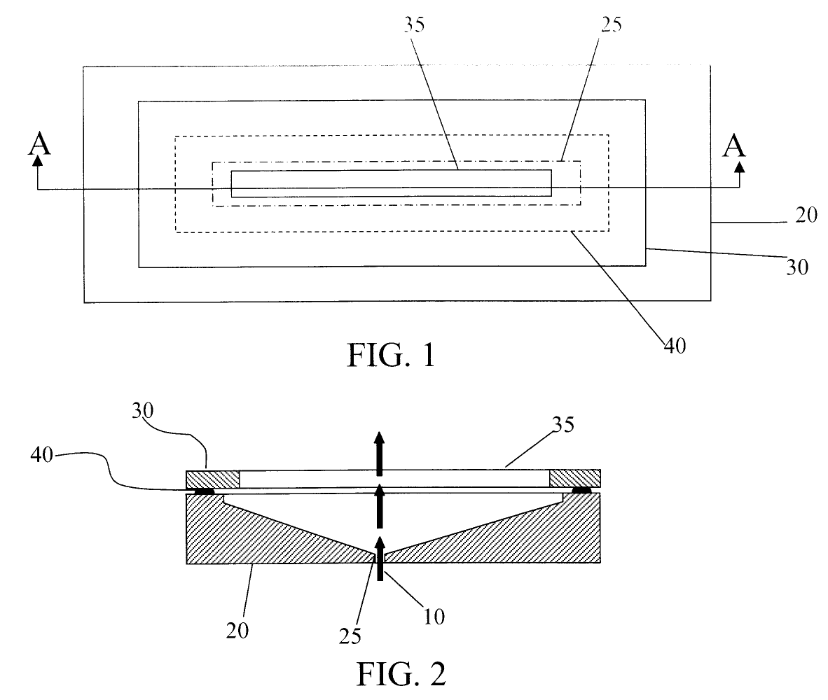

An ink jet printhead includes at least one fluid flow path for movement of ink from an ink reservoir to a nozzle or fluid ejector. As shown in FIGS. 1 and 2, the fluid flow path 10 through at least a portion of the ink jet printhead can be defined by a first substrate 20, a second substrate 30, and an adhesive sealant 40 bonding the first substrate 20 to the second substrate 30. As shown in FIGS. 1 and 2, the adhesive sealant surrounds a throughhole 25 in the first substrate and a throughhole 35 in the second substrate, such that fluid passing through throughhole 25 is bounded by the sealant and directed towards throughhole 35, forming fluid flow path 10.

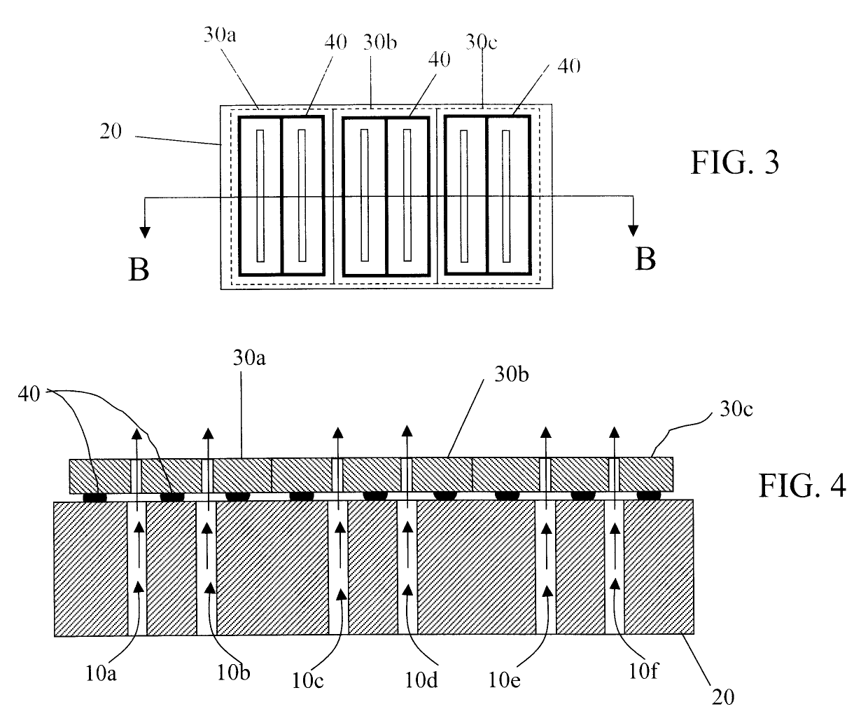

As shown in FIGS. 3 and 4, multiple fluid flow paths 10a, 10b, 10c, 10d, 10e, and 10f can be formed using a single first substrate 20 and multiple second substrates 30a, 30b, 30c. In this example, each of the second substrates contains two throughholes 35. The adhesive sealant 40 can be used to create separate fluid flow paths, for example, to form separate flow paths for each type of ink, such as black, cyan, yellow, and magenta.

Whether for drop-on-demand or continuous inkjet, an important goal of inkjet printing is to print pages quickly. Printing throughput is partly determined by the length of the region containing drop generators or nozzles on the ink jet printheads. A longer printhead is able to print a wider swath on the media, and is therefore able to print a page more quickly because fewer passes are required. Ink jet printheads continue to increase in size, increasing thermal and shear stress, flex, and fragility of the printhead. Use of a bismaleimide-containing adhesive sealant to form fluid flow paths in the printheads as described herein reduces stress, maintains adhesion during flexion, and provides a strong fluid-tight bond between substrates in such large printheads, reducing breakage.

The adhesive sealant can be used to join one or more throughhole from the first substrate to one or more throughhole of the second substrate. For example, there can be a one-to-one correspondence of throughholes, or a one-to-x correspondence, or an x-to-one correspondence, where x is two or more. In such cases, the fluid flow path created can have one or more branch, and can be branched one or more times. The fluid flow path can pass through two or more substrates or components of a device.

### EXAMPLES

Table 1 compares a bismaleimide-containing adhesive sealant and an epoxy as used to join a ceramic substrate and a silicon substrate in an ink jet printhead. An ink jet printhead was chosen to test because of the shear stress, thermal stress, flex stress, and harsh chemical environment imposed on the adhesive sealant used to form a fluid flow path therein. As can be seen from Table 1, the bismaleimide-containing adhesive sealant has many advantages over epoxies for use in ink jet printhead applications.

TABLE 1

| REQUIREMENT | BISMALEIMIDE | EPOXY |
|---|---|---|
| Ink resistant | + | − |
| Low outgassing | + | − |
| Forms void-free bondlines | + | − |
| Reduce/eliminate die warpage | + | − |
| Reduce/eliminate die cracking | + | − |
| Low temperature cure | + | − |
| Low moisture absorption | + | − |
| Thermal conductivity | Comparable | Comparable |

A bismaleimide-containing adhesive sealant, Henkel QMI 550EC (Henkel Technologies, San Diego, Calif., USA) was compared to several epoxies as follows, wherein Epoxy 1 was Bondline 7258 from Bondline Electronic Adhesives, Sunnyvale, Calif., and epoxy 2 was Ablebond 84-1LMI-SR4 from Ablestik Laboratories, Rancho Dominguez, Calif.

Three disks of each material measuring 14 mm diameter by 4.75 mm thick were molded in Teflon molds. Each disk was weighed and hardness tested using a Shore D hardness tester. Each disk was then immersed in an ink for six weeks at about 60° C. The inks were aqueous based systems containing some of but not limited to, the following or similar components: water, organic solvents organic acids, pigments, dyes, binders, humectants, surfactants and biocides. Ink 1 was black, ink 2 was cyan, and ink 3 was a formulation of professional printing quality. Afterwards, each disk was removed from the ink, rinsed in deionized water, and dried with a cloth. The dried discs were weighed and tested with a Shore D hardness tester. The percent weight change and change in hardness were then calculated for each disc. Results are shown in Table 2 below.

To demonstrate shear strength, for the bismaleimide-containing adhesive sealant and each epoxy as described above, three alumina tiles were prepared as follows. Twenty-eight dots of adhesive were dispensed in a grid pattern using an automated adhesive dispenser onto an alumina tile measuring 32 mm×45 mm×1 mm. Twenty-eight 3 mm×3 mm silicon tiles were simultaneously placed onto the dots of adhesive and pressed into position using precision placement fixturing. The populated alumina tile was placed in an oven at 125° C. and allowed to cure for 30 minutes. The alumina tile was then removed from the oven and allowed to cool to room temperature. Ten random silicon tiles were sheared off the alumina tiles using a Dage 4000 die shear tester. The alumina tile with the remaining silicon tiles was then placed in ink (described above) for six weeks at 60° C. temperature. Upon removal from the ink, the populated alumina tile was rinsed in deionized water, dried with a cloth, and the remainder of the silicon tiles sheared off. The percent change in die shear strength was then calculated, and is shown in Table 2.

TABLE 2

| Parameter | Adhesive Type | Ink 1 | Ink 2 | Ink 3 |
|---|---|---|---|---|
| % weight change | Bismaleimide | +0.1 | +0.5 | +0.3 |
| | Epoxy 1 | +15 | +12 | +11 |
| | Epoxy 2 | +2 | +3 | +3 |
| % hardness change (Shore D) | Bismaleimide | 0 | 0 | 0 |
| | Epoxy 1 | −46 | −53 | −55 |
| | Epoxy 2 | −15 | −19 | −3 |
| % change in shear strength | Bismaleimide | 0 | 0 | 0 |
| | Epoxy 1 | −75 | −67 | −67 |
| | Epoxy 2 | −27 | −7 | −32 |

As shown in Table 2, the bismaleimide-containing adhesive sealant performed better than the epoxies, experiencing little or no change in weight, hardness, or shear strength.

The invention has been described with reference to a preferred embodiment. However, it will be appreciated that variations and modifications can be effected by a person of ordinary skill in the art without departing from the scope of the invention.

### PARTS LIST

10 fluid flow path
20 first substrate
25 first substrate throughhole
30 second substrate
35 second substrate throughhole
40 adhesive sealant

1. A fluid flow path for a microfluidic device, wherein the fluid flow path comprises an inlet and at least one outlet, and is defined by:
a first substrate having a first surface and a second surface, and at least one fluid via;
a second substrate having a first surface and a second surface, and one or more fluid via; and
an adhesive sealant between the second surface of the first substrate and the first surface of the second substrate, wherein the sealant surrounds at least one first substrate fluid via and at least one second substrate fluid via such that fluid entering at least one first substrate fluid via flows through the via, through an area bounded by the adhesive sealant, and through one or more second substrate fluid via,
wherein the adhesive sealant comprises bismaleimide.

2. The fluid reservoir of claim 1, wherein the adhesive sealant further comprises a thermally conductive filler material.

3. The fluid reservoir of claim 1, wherein the adhesive sealant further comprises silver.

4. The fluid reservoir of claim 1, wherein the adhesive sealant has a curing temperature of 125° C. or less.

5. A microfluidic device comprising:
a first substrate having a first surface and a second surface, and at least one fluid via;
a second substrate having a first surface and a second surface, and one or more fluid via; and
at least one fluid flow path defined by at least one first substrate fluid via, one or more second substrate fluid via, and an adhesive sealant between the second surface of the first substrate and the first surface of the second substrate;
wherein the adhesive sealant comprises bismaleimide.

6. The microfluidic device of claim 5, comprising two or more fluid flow paths.

7. The microfluidic device of claim 5, comprising two or more fluid flow paths, wherein at least one fluid flow path is isolated from at least one other fluid flow path by the adhesive sealant.

8. The microfluidic device of claim 5, wherein the device is an inkjet print head.

9. The microfluidic device of claim 5, wherein the second substrate has a long dimension of at least 1.5 cm.

10. The microfluidic device of claim 5, wherein the second substrate has a long dimension of at least 5 cm.

11. The microfluidic device of claim 5, wherein the adhesive sealant further comprises a thermally conductive filler material.

12. The microfluidic device of claim 5, wherein the adhesive sealant further comprises silver.

13. The microfluidic device of claim 5, wherein the adhesive sealant has a curing temperature of 125° C. or less.

14. The microfluidic device of claim 13, wherein the adhesive sealant has a cure time of 30 minutes or less.

15. The microfluidic device of claim 5, wherein one or more second substrate fluid via is associated with at least one heating element on the second side of the second substrate.

16. The microfluidic device of claim 5, comprising two or more fluid flow paths wherein at least one fluid flow path has a different fluid from at least one other fluid flow path.

17. The microfluidic device of claim 5, comprising two or more second substrates.

18. The microfluidic device of claim 5, wherein the first substrate, the second substrate, or both, further comprise one or more alignment feature.

19. The microfluidic device of claim 5, wherein the first substrate is in contact with a thermoplastic material having a softening point of 140° C. or less.

20. The microfluidic device of claim 19, wherein the thermoplastic material has one or more alignment feature.

21. A printhead comprising:
a thermoplastic material;
a first substrate in contact with the thermoplastic material, the first substrate having a first surface, a second surface, and at least one fluid via;
a second substrate having a first surface, a second surface, and one or more fluid via; and
at least one fluid flow path defined by at least one first substrate fluid via, one or more second substrate fluid via, and an adhesive sealant between the second surface of the first substrate and the first surface of the second substrate,
wherein the adhesive sealant comprises bismaleimide.

22. A method of forming a fluid flow path, comprising:
forming a first substrate having a first surface, a second surface, and at least one fluid via;
forming a second substrate having a first surface, a second surface, and one or more fluid via;
applying an adhesive sealant between the second surface of the first substrate and the first surface of the second substrate, wherein the sealant surrounds at least one first substrate fluid via and one or more second substrate fluid via;
wherein the adhesive sealant comprises bismaleimide.

23. The method of claim 22, wherein the adhesive sealant further comprises a thermally conductive filler material.

24. The method of claim 22, wherein the adhesive sealant further comprises silver.

25. The method of claim 22, wherein the adhesive sealant has a curing temperature of 125° C. or less.

26. The method of claim 22, wherein applying the adhesive sealant comprises dispensing, screen printing, or stencil printing the adhesive sealant.

27. The method of claim 22, wherein applying the adhesive sealant comprises applying a B-staged film.

28. A method of forming a microfluidic device comprising:
forming a first substrate having a first surface, a second surface, and at least one fluid via;
forming a second substrate having a first surface, a second surface, and one or more fluid via;
applying an adhesive sealant between the second surface of the first substrate and the first surface of the second substrate to form at least one fluid flow path comprising at least one first substrate fluid via, one or more second substrate fluid via, and the area bounded by the adhesive sealant;
wherein the adhesive sealant comprises bismaleimide.

29. The method of claim 28, wherein the adhesive sealant further comprises a thermally conductive filler material.

30. The method of claim 28, wherein the adhesive sealant further comprises silver.

31. The method of claim 28, wherein the adhesive sealant has a curing temperature of 125° C. or less.

32. The method of claim 28, wherein applying the adhesive sealant comprises dispensing, screen printing, or stencil printing.

33. The method of claim 28, wherein forming a first substrate includes placing the first substrate in contact with a thermoplastic material, wherein the thermoplastic material has a softening point of less than 140° C.

34. A method of forming a printhead comprising:
injection molding a thermoplastic material;
configuring a first substrate to be in contact with the thermoplastic material, the first substrate having a first surface, a second surface, and at least one fluid via:
obtaining a second substrate having a first surface, a second surface, and one or more fluid via; and
applying an adhesive sealant between the second surface of the first substrate and the first surface of the second substrate to form at least one fluid flow path comprising at least one first substrate fluid via, one or more second substrate fluid via, and the area bounded by the adhesive sealant,
wherein the adhesive sealant comprises bismaleimide.

35. The method of claim 34, wherein the adhesive sealant has a curing temperature of 125° C. or less.

36. The method of claim 34, wherein applying the adhesive sealant comprises dispensing, screen printing, or stencil printing.

37. The method of claim 34, wherein the thermoplastic material has a softening point of less than 140° C.
